(19) United States
(12) Patent Application Publication
(10) Pub. No.: US 2006/0196127 A1
(43) Pub. Date: Sep. 7, 2006

(54) OPPOSED WINDOW PAIRING FOR LIMITED VIEWING THERE THROUGH

(76) Inventor: Chad Dustin Tillman, Charlotte, NC (US)

Correspondence Address: TILLMAN WRIGHT, PLLC, PO BOX 471581, CHARLOTTE, NC, 28247, US

(21) Appl. No.: 11/275,942

(22) Filed: Feb. 6, 2006

Related U.S. Application Data
(60) Provisional application No. 60/593,694, filed on Feb. 6, 2005.

(51) Int. Cl. E06B 7/00

(52) U.S. Cl. 52/171.1; 52/171.3

(57) ABSTRACT

A combination includes a first window configured to polarize light passing there through in a first plane; and a second window configured to polarize light passing there through in a second plane, the second plane being generally orthogonal to the first plane. The first window and the second window are disposed in opposing dispositions such that a line-of-sight extends between and to each window. Accordingly, a person's view through both windows is substantially blocked, but an individual view by a person through each window is not blocked. The opposed windows may form part of opposing sides of buildings or houses, or opposing sides of a container, such as an aquarium. The opposed windows further may form part of opposing rooms, such as offices or conference rooms.

### CROSS-REFERENCE TO RELATED APPLICATIONS

The present application is a nonprovisional patent application of, and claims priority under 35 U.S.C. § 119(e) to, U.S. provisional patent application Ser. No. 60/593,694, filed Feb. 6, 2005, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention relates to the blocking or limiting of a person's view along a line of sight through two or more windows.

Currently, a person's view through two or more windows is blocked or limited by blocking or limiting the view through a particular one of the windows using a physical object to obstruct the view, such as a blind or shade. Additionally, or alternatively, the particular window further may include reflective characteristics for blocking of a person's view there through. In each of these scenarios, the view through both windows is blocked or limited by blocking or limiting the person's view through one of the two windows.

A need exists for an improvement in which a person's view is not blocked or limited through any particular window but, rather, is limited or blocked only with respect to the view through both windows combined. This, and other needs, are addressed by one or more embodiments of the present invention, as set forth below.

### SUMMARY OF THE INVENTION

Broadly defined, the present invention generally relates to the blocking or limiting of a person's view along a line of sight through two or more windows, but not the person's view through either of the two windows taken individually.

In preferred embodiments, each window filters electromagnetic radiation, especially visible light, with respect to a particular orientation of propagation of the electromagnetic radiation. In this respect, each window preferably acts as a polarizing filter and, in preferred embodiments, includes polarized glass or a polarized film that is applied to the transparent material of the window. The polarization of the visible light passing through the window permits a person to view through the window itself when considered individually; however, in accordance with the present invention, a second window taken in conjunction with the first window acts together to block or limit the person's view through both windows. In this regard, the second window preferably filters light in a generally orthogonal orientation to the first window such that light passing through the first window is blocked or substantially limited by the second window.

The present invention includes many aspects and features. Moreover, while many aspects and features relate to, and are described in, the context of various implementations, the present invention is not limited to use only in the discussed implementations, as will become apparent from the following summaries and detailed descriptions of aspects, features, and one or more embodiments of the present invention. In addition to the aforementioned aspects and features of the present invention, it should be noted that the present invention further includes the various possible combinations of such aspects and features. Examples of such combinations are illustrated in the detailed description set forth below.

### BRIEF DESCRIPTION OF THE DRAWINGS

One or more embodiments of the present invention will now be described in detail with reference to the accompanying drawings, wherein the same elements are referred to with the same reference numerals, and wherein,

FIG. 1 illustrates light that propagates in an X-Y plane and light that propagates in an X-Z plane that is orthogonal thereto;

FIG. 2 illustrates a view along the X axis of the different light waves of FIG. 1, wherein the orthogonal relationship of the two light waves is best shown;

FIG. 3 illustrates an office layout in accordance with a first implementation of the present invention, wherein opposed windows along an office corridor or hallway act in conjunction with one another to block a person's concurrent view through both windows;

FIG. 4 illustrates a neighborhood including at least two homes built very close to one another and having opposed windows (such as bathroom and bedroom windows) facing one another;

FIG. 5 illustrates a layout of the residential neighborhood of FIG. 4 in accordance with a second implementation of the present invention, wherein opposed windows of neighboring houses act in conjunction with one another to block a person's concurrent view from one house into the adjacent house;

FIG. 6 illustrates yet another implementation of the present invention in which opposed windows of a container act in cooperation with one another to block, limit, or impede a person's view through both windows while permitting a person to view the inside of the container through either of the windows;

FIG. 7 illustrates a variation of the container of FIG. 6, wherein regions or areas of each of the opposed windows act in cooperation with one another to block, limit, or impede a person's view through both windows while permitting a person to view the inside of the container through either of the windows; and

FIG. 8 illustrates an implementation of the present invention in which opposed windows of an aquarium or fishbowl act in cooperation with one another to block, limit, or impede a person's view through both windows while permitting a person to view the inside of the container through any of the windows.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein as understood by the Ordinary Artisan based on the contextual use of such term differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

With particular regard to the present invention, “window” as used herein broadly means “an object, or some portion thereof, that permits the transmission there through of visible light” and may be formed of glass, plastic, or other transparent material. A window may comprise a panel or pane of a transparent material, and may further include a film applied to the surface thereof or disposed therein.

Furthermore, “opposed” as used herein in reference to two objects broadly means that “the first object has at least a portion thereof that registers in line-of-sight with at least a portion of the other object.”

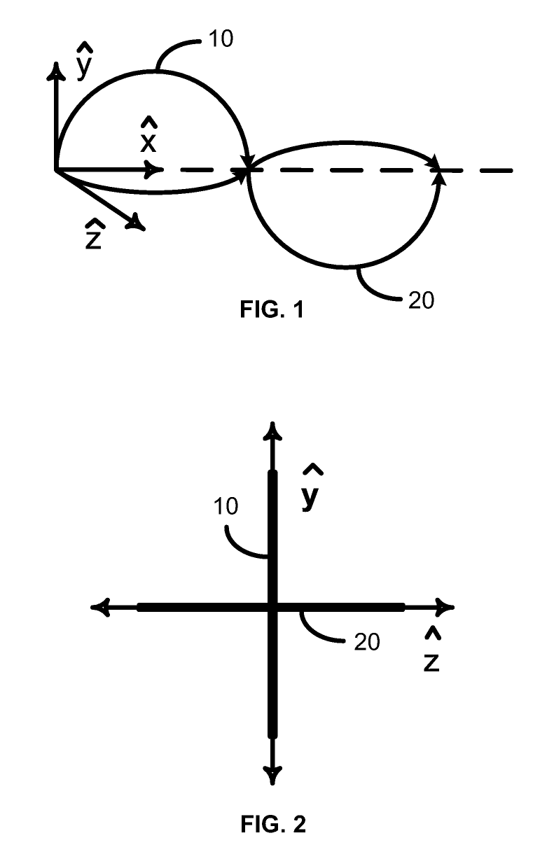

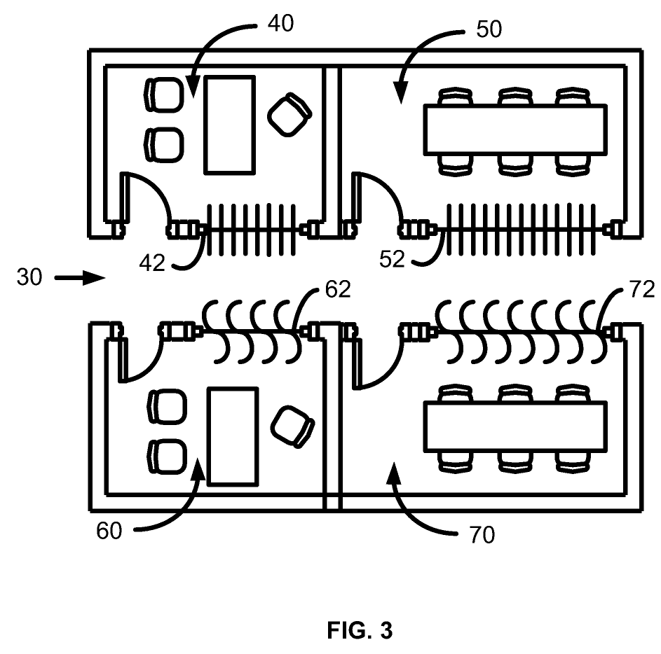

Turning now to FIG. 1, two waves of light are shown propagating relative to an artesian coordinate system including an X axis, a Y axis, and a Z axis. One wave 10 propagates in the X-Y plane and another wave 20 propagates in the X-Z plane, wherein the two planes are disposed orthogonally to one another. With reference to FIG. 2, both light waves are illustrated from a view along the Z axis to best illustrate their orientation at a right angle to each another. Through the drawings, light waves represented by straight line segments represent light that propagates in a first plane and light represented by curved line segments represents light that propagates in a second, substantially orthogonal plane, similar to the light waves of FIGS. 1-2.

It is well known that light may propagate as illustrated in FIGS. 1-2. Furthermore, it is well known how to polarize light so that the light only propagates in a certain plane. In accordance with embodiments and implementations of the present invention discussed now with reference to FIGS. 4-8, the windows of these embodiments and implementations preferably polarize visible light passing there through into certain planes utilizing known polarization techniques.

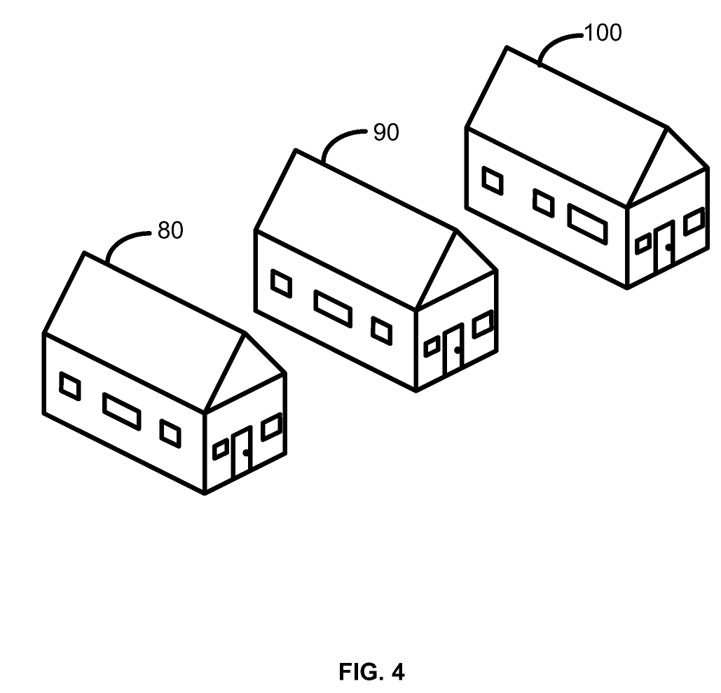

Accordingly, an exemplary office layout in accordance with a first implementation of the present invention is shown in FIG. 3. The office layout includes a hallway or corridor 30 extending between a pair of rooms disposed on either side of the corridor. A first pair of rooms includes a first office 40 and a first conference room 50, and the second pair of rooms includes a second office 60 and a second conference room 70. The two offices 40,60 are disposed opposite one another, and the two conference rooms 50,70 are disposed opposite one another. Each of the four rooms includes at least one window for viewing into the room from the corridor 30, as is conventional, in order to avoid a sense of a confining enclosure when in the room.

Due to the arrangement of the rooms, however, a person in, for example, either office can see into the opposite office. If both rooms are occupied, this can cause obvious, unnecessary distractions. Conventionally, shades or blinds are provided in each respective office for limiting or blocking the view into that office both from the corridor as well as from the other, opposing office.

In accordance with the present invention, the window 42 of the first office 40 polarizes light in a first plane, and the opposed window 62 of the second office 60 polarizes light in a second plane that is orthogonal to the first plane. Consequently, a person in either office cannot view into the opposed office. Light traveling from an office through the window of that office is blocked by the window of the other office. On the other hand, a person passing through the corridor 30 is able to view into either of the two offices 40,60. This is especially convenient if the person is looking for the particular person to which the office belongs when the door is shut, as the searcher can look into the office to see if the person is in there and can determine whether that person is available or unavailable, such as with another person or on the phone. Distractions furthermore are limited because of the transient nature of the person in the corridor. Consequently, blinds, shades, or other physical obstructions are unnecessary in order to preclude the view into one office from the other office.

Similar to the offices, windows 52,72 of the first and second conference rooms 50,70 also face one another. The window 52 of the first conference room 50 polarizes light in a first plane, and the opposed window 72 of the second conference room 70 polarizes light in a second plane that is orthogonal to the first plane. Consequently, a person in either conference room cannot view into the opposed conference room. Light traveling from a conference room through the window of that conference room is blocked by the window of the other conference room. On the other hand, a person passing through the corridor can view into either conference room. This is especially convenient if the person is searching for an available conference room or for a particular person. Distractions furthermore are limited because of the transient nature of the person in the corridor, which is in contrast to the occupants of a first conference room who may occupy the first conference room for as long as, or longer than, occupants of the second conference room, or vice-versa. Consequently, blinds, shades, or other physical obstructions are unnecessary in order to preclude the view into one conference room from the other conference room.

A second implementation of the present invention relates to residential housing. In this regard, FIG. 4 illustrates a neighborhood having at least three houses 80,90,100 built very close to one another, as is conventional. In fact, opposing windows of bathrooms and bedrooms typically face one another in such residential construction, whereby a person standing within the bathroom or bedroom of one house may readily look into the bathroom or bedroom of the neighboring house.

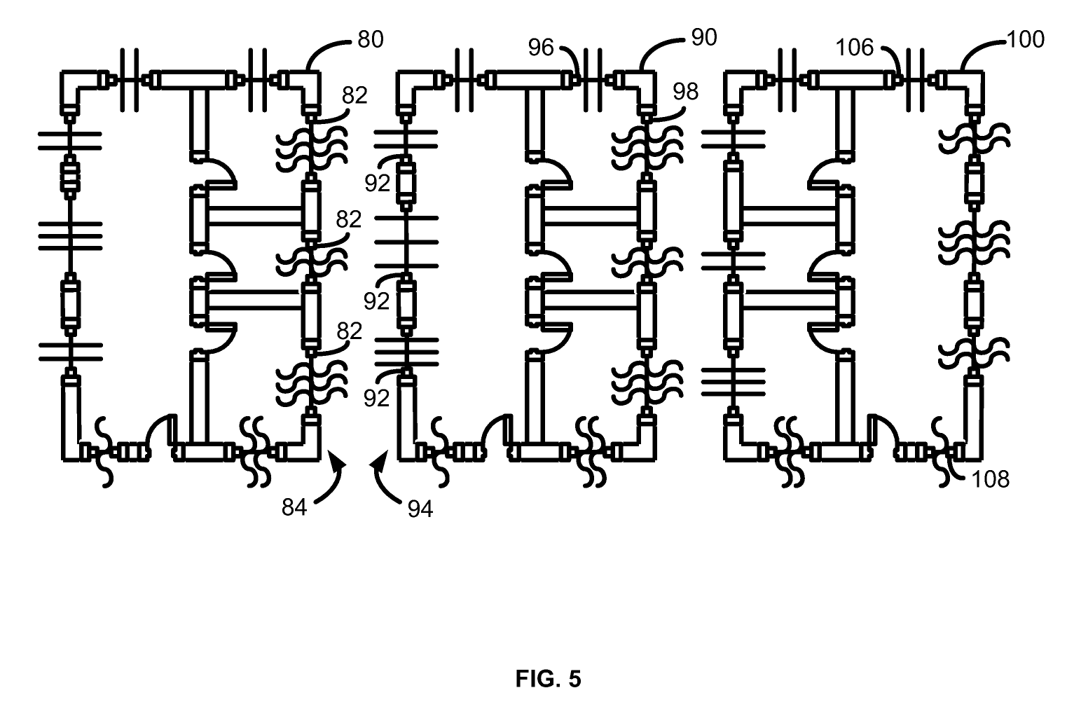

A layout of the three houses 80,90,100 of FIG. 4 is illustrated in FIG. 5. In accordance with the second implementation of the present invention, the windows 82 of a first side 84 of a first house 80 polarize light that passes there through in a first plane that is generally orthogonal to the plane in which light passing through the windows 92 of the opposing side 94 of the neighboring house 90 is polarized. Accordingly, a person standing within the first house 80 cannot readily view into the adjacent house 90 through any of the opposed windows 92 of the opposing side 94 of the neighboring house 90. Privacy within each neighboring house thereby is provided without precluding an outside view from within, or into, either house.

As will further become apparent from close inspection of FIG. 5, the arrangements of the windows having opposite polarization within any particular house reveal that a person outside of a house cannot get an outside view through aligned windows of the particular house even when the outside view through any window is otherwise unobstructed through the house. For example, window 96 and window 98 have opposite polarizations thereby blocking concurrent view there through; and window 106 and window 108 have opposite polarizations thereby blocking concurrent view there through.

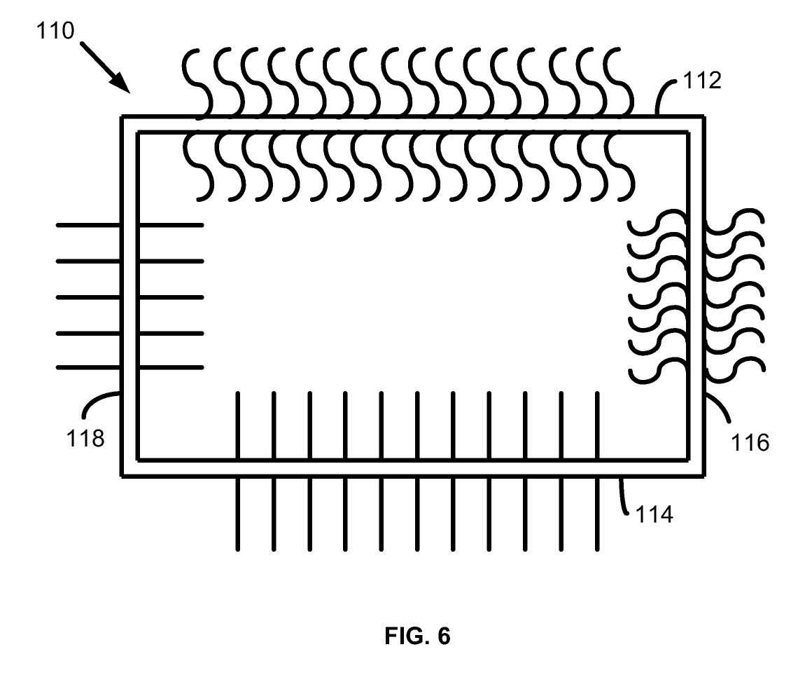

FIG. 6 illustrates yet another implementation of the present invention. In this regard, a container 110 having four sides is illustrated, wherein each side is transparent and comprises a window. In accordance with the present invention, window 112 of the container acts in cooperation with opposed window 114 to block (i.e., limit or impede) a person's view through both windows 112,114 while permitting a person to view the inside of the container 110 through either of the windows 112,114. As illustrated, this is accomplished through the generally orthogonal or “opposite” polarization of light that is accomplished by the opposed windows 112,114. Similarly, window 116 of the container acts in cooperation with opposed window 118 to block a person's view through both windows 116,118 while permitting a person to view the inside of the container 110 through either of the windows 116,118.

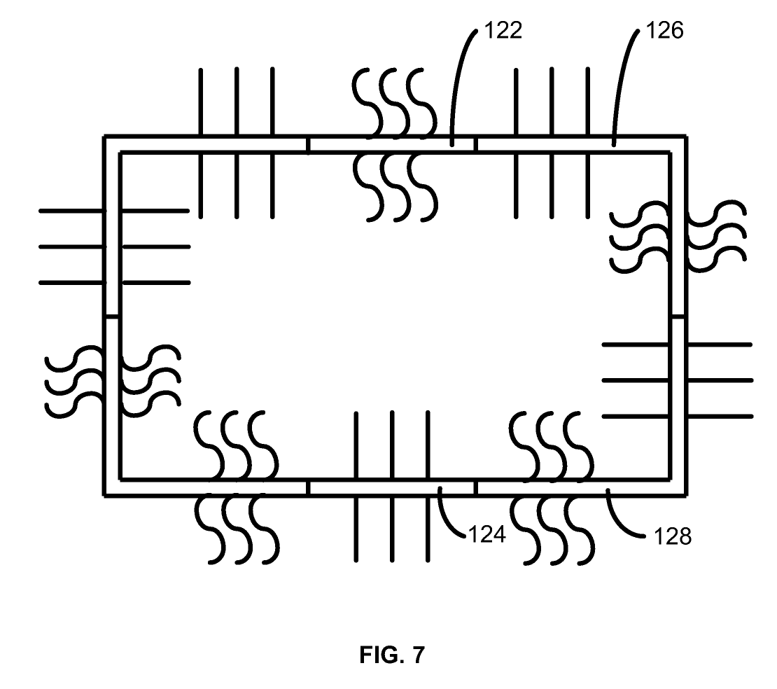

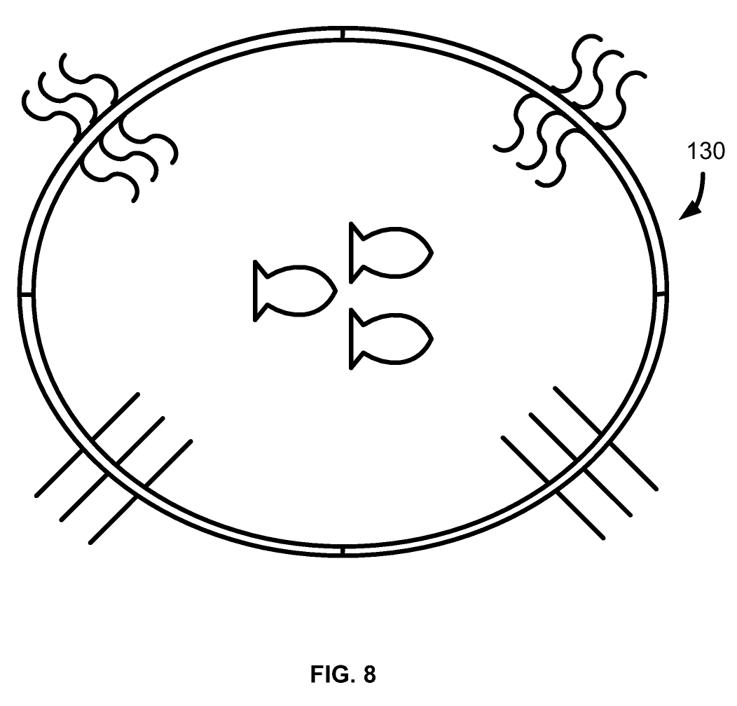

As illustrated in FIG. 7, each window of the container 110 of FIG. 6 may include portions or areas thereof having opposite polarizations of light, whereby the window itself does not uniformly polarize light. In this variation, for example, a portion 122 of one window that directly opposes a portion 124 of the opposite window includes an opposite polarity so that one cannot concurrently view through both portions 122,124. Similarly, for example, portion 126 of one window that directly opposes portion 128 of the opposite window includes an opposite polarity so that one cannot concurrently view through both portions 126,128.

FIG. 8 illustrates an implementation of the present invention in which an aquarium 130 includes the opposed windows of opposite polarizations of light. Accordingly, this container 130 generally permits a person to view the inside of the aquarium 130 and the fish therein through any of the windows, but does not permit general viewing through the aquarium 130 of objects on the other side of the aquarium. 130. This implementation of the invention is beneficial when the aquarium is used to partition or divide a room, such use commonly being found in restaurants. This implementation further includes the advantage of providing a beneficial, contrasting backdrop for viewing fish in the aquarium 130, especially exotic fish, as the opposed window would appear darkened when viewed through the window directly across from it.

Other implementations fall within the scope of the present invention and include, for example, opposed windows of any type of buildings polarizing light in orthogonal planes relative to one another to preclude the view into one building from within the other building. Such buildings could include, for example, a high rise office building that faces a high rise hotel.

1-31. (canceled)

32. A container, comprising,
(a) a first window configured to polarize light passing there through, in a first plane; and
(b) a second window configured to polarize light, passing there through, in a second plane, said second plane being generally orthogonal to said first plane;
(c) wherein said first window and said second window are disposed in positions such that,
(i) a line of sight extends between and to each said window, and
(ii) a concurrent view by, a person through both windows is substantially blocked but an individual view by a person through either window is not blocked.

33. The container of claim 32 wherein said first window and said second window are disposed directly opposite one another.

34. The container of claim 32, wherein said first window and said second window are part of opposing sides of the container.

35. The container of claim 32, wherein the container comprises four sides and wherein the container has a rectangular profile.

36. The container of claim 32, wherein a said window comprises polarized glass.

37. The container of claim 32, wherein a said window comprises polarized film.

38. The container of claim 32, wherein the container comprises a waterproof container for holding a liquid.

39. A container, comprising,
(a) a first window with transparent areas configured to polarize light, passing there through, in orthogonal planes, whereby said first window itself does not uniformly polarize light; and
(b) a second window with transparent areas configured to polarize light, passing there through, in orthogonal planes, whereby said second window itself does not uniformly polarize light;
(c) wherein said first window and said second window are disposed in positions such that,
(i) a line of sight extends between and to a first said area of said first window and a first said area of said second window, and
(ii) a concurrent view by a person through both said first area of said first window and said first area of said second window is substantially blocked but an individual view by a person through either of said first areas of said first and second windows is not blocked.

40. The container of claim 39, wherein said first windows and said second window are disposed in positions further such that,
(i) a line of sight extends between and to a second said area of said first window and a second said area of said second window, and
(ii) a concurrent view by a person through both said second area of said first window and said second area of said second window is substantially blocked but an individual view by a person through either of said second areas of said first and second windows is not blocked.

41. A container, comprising,
(a) a first window portion configured to polarize light, passing there through, in a first plane; and
(b) a second window portion configured to polarize light, passing there through, in a second plane, said second plane beings, generally orthogonal to said first plane;
(c) wherein said first window portion and said second window portion are disposed such that,
(i) a line of sight extends between and to each said window portion, and
(ii) a concurrent view by a person through both window portions is substantially blocked but an individual view by a person through either window portion is not blocked.

42. The container of claim 41, wherein the container is oval shaped.

43. The container of claim 41, wherein the container comprises a waterproof container for holding a liquid.

44. A method of making a container that blocks a concurrent view by a person through window portions of the container but that permits an individual view into the container by a person through each of the window portions, comprising the steps of:
(a) applying in first orientation a polarizing film to a first of the window portions, the film applied such that it polarizes light in a first plane; and
(b) applying in a second orientation polarizing film to a second of the window portions, the film applied such that it polarizes light in a second plane orthogonal to the first plane.

45-57. (canceled)

58. The container of claim 32, wherein the container comprises an aquarium.

59. The container of claim 55, wherein said aquarium is configured to partition a room.

60. The container claim 39, wherein the container comprises an aquarium.

61. The container of claim 60, wherein said aquarium is configured to partition a room.

62. The container of claim 41, wherein the container comprises an aquarium.

63. The container of claim 62, wherein said aquarium is configured to partition a room.

64. The method of claim 44, wherein the container comprises an aquarium.
